(19) United States
(12) Patent Application Publication
(10) Pub. No.: US 2009/0165606 A1
(43) Pub. Date: Jul. 2, 2009

(54) QUICK RELEASE DEVICE FOR RELEASING SCREW BIT FROM SOCKET

(76) Inventor: Chih-Ching Hsien, Taichung Hsien (TW)

Correspondence Address: Chien-Hui SU, P.O. Box 70-121 Taichung, TAICHUNG CITY, 40899, TW

(21) Appl. No.: 12/400,803

(22) Filed: Mar. 10, 2009

Related U.S. Application Data
(63) Continuation-in-part of application No. 11/328,122, filed on Jan. 10, 2006.

(51) Int. Cl. B25B 23/00

(52) U.S. Cl. 81/438

(57) ABSTRACT

A quick release bit socket assembly includes a socket having a first recess for receiving a screw bit, and a second recess defined in a second end of the socket so as to receive a push rod. A passage is in communication between the first and second recesses. The push rod includes a head and a shank to which a spring is mounted. The shank extends through the first recess, the passage and is inserted in the second recess. The spring is biased between the head and an inner bottom of the first recess. The screw bit is positioned by a positioning device is the second recess and can be pushed out from the second recess when the push rod is pushed toward the screw bit.

### CROSS-REFERENCE TO RELATED APPLICATION

This application is a Continuation-in-part Application of Ser. No. 11/328,122, filed 10 Jan. 2006, and entitled “QUICK RELEASE DEVICE FOR RELEASING SCREW BIT FROM SOCKET”, now pending.

### BACKGROUND OF THE INVENTION

1. Field of the Invention

The present invention relates to a hand tool, and more particularly to a quick release device for a screw bit.

2. Description of Related Art

A conventional screw bit socket assembly in accordance with the prior art shown in FIG. 17 comprises a cruciform tube 30 and a positioning bead 31 extends inward from an inner periphery of the passage of the tube 30. A screw bit 40 has one end inserted into the passage and includes a notch defined in an outer periphery thereof so that the bead 31 is engaged with the notch to position the screw bit 40 in the passage. Nevertheless, when the screw bit 40 is to be removed from the passage. The user has to hold the screw bit 40 outside the tube 30 and pull the screw bit 40 in its longitudinal direction out from the tube 30. The screw bit 40 has a small diameter and the bead 31 is securely engaged with the notch, so that it is difficult to easily pull the screw bit 40 out from the passage. It could be worse when the user' hand is attached with grease.

The present invention intends to provide a quick release device which includes a push rod located at an end of the socket or tube opposite to the end with the screw bit being inserted. The screw bit is easily pushed out from the socket by pushing the push rod toward the screw bit.

### SUMMARY OF THE INVENTION

The present invention relates to a quick release bit socket assembly which comprises a socket having a first recess for receiving a screw bit, and a second recess defined in a second end of the socket so as to receive a push rod. A passage is in communication between the first and second recesses. The push rod includes a head and a shank to which a spring is mounted. The shank extends through the first recess, the passage and is inserted in the second recess. The spring is biased between the head and an inner bottom of the first recess. The screw bit is positioned by a positioning device is the second recess and can be pushed out from the second recess when the push rod is pushed toward the screw bit.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view to show a first embodiment of the quick release bit socket assembly of the present invention;

FIG. 2 is a cross sectional view to show the quick release bit socket assembly of the present invention;

FIG. 3 shows the quick release bit socket assembly of the present invention and a ratchet wrench;

FIG. 4 shows the quick release bit socket assembly of the present invention connected to the ratchet wrench;

FIG. 5 is a cross sectional view to show that the quick release bit socket assembly of the present invention is connected to the ratchet wrench;

FIG. 6 is a cross sectional view to show that the screw bit is pushed out from the socket by pushing the push rod;

FIG. 7 is an exploded view to show a second embodiment of the quick release bit socket assembly of the present invention;

FIG. 8 is a cross sectional view to show a second embodiment of the quick release bit socket assembly of the present invention;

FIG. 9 is a cross sectional view to show that the second embodiment of the quick release bit socket assembly of the present invention is connected to the ratchet wrench;

FIG. 10 is a cross sectional view to show that the screw bit of the second embodiment of the quick release bit socket assembly is pushed out from the socket by pushing the push rod;

FIG. 11 is a cross sectional view to show a third embodiment of the quick release screw bit socket assembly of the present invention;

FIG. 12 is a cross sectional view to show that the third embodiment of the quick release bit socket assembly of the present invention is connected to the ratchet wrench;

FIG. 13 is a cross sectional view to show that the screw bit of the third embodiment of the quick release bit socket assembly is pushed out from the socket by pushing the push rod;

FIG. 14 discloses another embodiment of the positioning device for positioning the screw bit;

FIG. 15 is a cross sectional view to show that the quick release bit socket assembly with the positioning device in FIG. 14 is connected to the ratchet wrench;

FIG. 16 is a cross sectional view to show that the screw bit is pushed out from the socket in FIG. 15; and

FIG. 17 shows a conventional screw bit socket assembly.

### DETAILED DESCRIPTION OF THE INVENTION

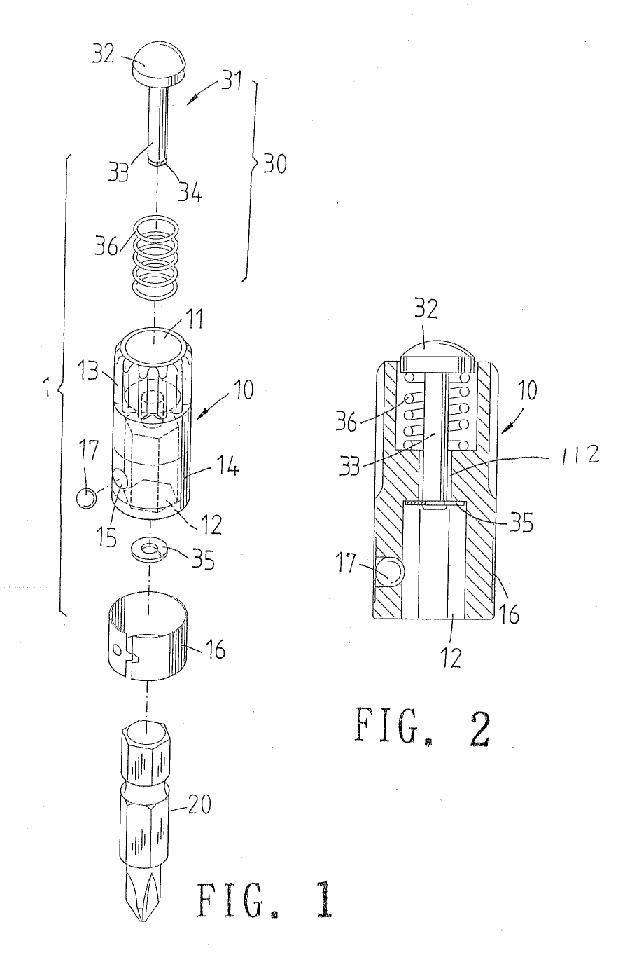

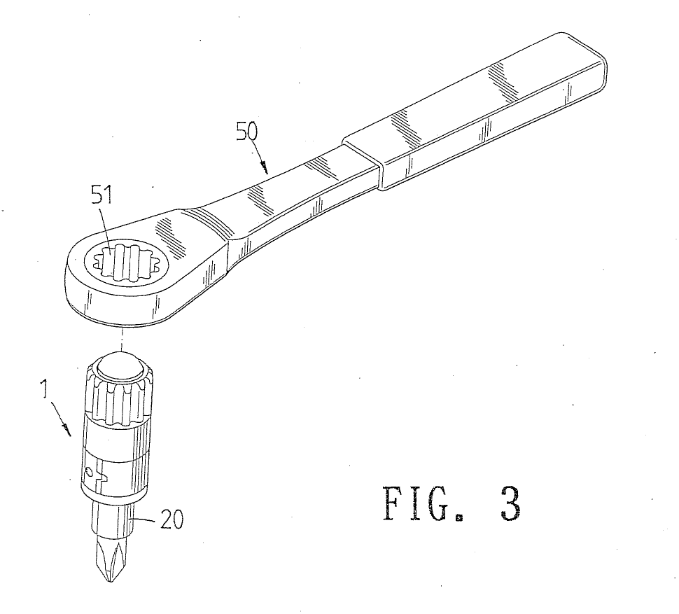

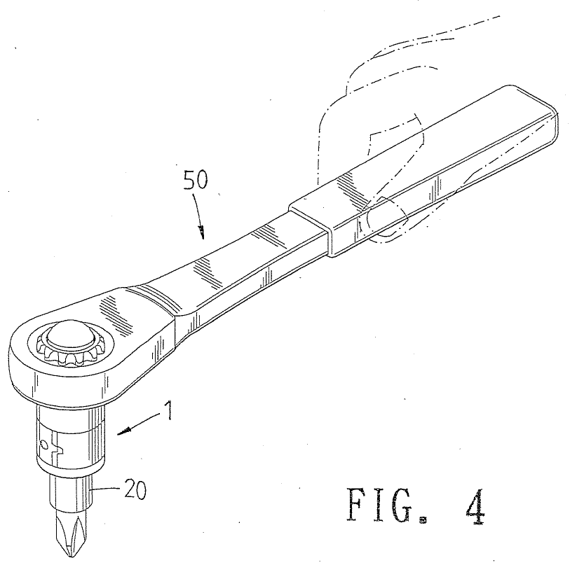

Referring to the drawings and initially to FIGS. 1-5, a quick release bit socket assembly 1 in accordance with the present invention comprises a socket 10 which has a first recess 11 defined in a first end thereof and a second recess 12 defined in a second end thereof. The second recess 12 is generally a hexagonal recess so as to receive a screw bit 20. A positioning device such as a positioning bead 17 is engaged with a side hole 15 defined through a wall of the socket 10 and a part of the bead 17 extends into the second recess 12 and engaged with the groove in the screw bit 20. An annular recessed area 14 is defined in an outer surface of the socket 10 and located close to the second end of the socket 10. A strip 16 is engaged with the annular recessed area 14 and in flush with the outer surface of the socket 10 and second seals the side hole 15. A passage 112 is in communication between the first and the second recesses 11, 12. The first end of the socket 10 includes a toothed outer surface 13 which is engaged with the engaging hole 51 of a ratchet wrench 50 as shown in FIG. 5.

A quick release device 30 includes a push rod 31 including a head 32 and a shank 33 which is connected to the head 32. A spring 36 is mounted to the shank 33 which extends through the first recess 11, the passage 112 and is inserted in the second recess 12. A C-shaped clip 35 is engaged with a groove 34 defined in an outer surface of a distal end of the shank 33 so that the push rod 31 is positioned in place. The spring 36 is biased between the head 32 and an inside of the first recess 11.

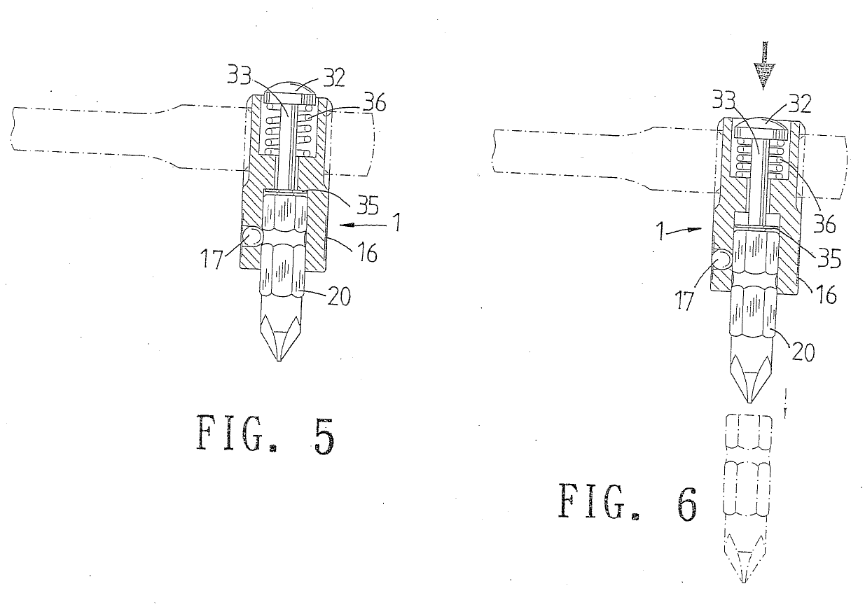

As shown in FIGS. 5 and 6, the user can easily pushed the head 32 of the push rod 31 toward the screw bit 20, the shank 33 is then lowered to push the screw bit 20 out from the second recess 12. By this way, the screw bit 20 can be easily separated from the socket 10.

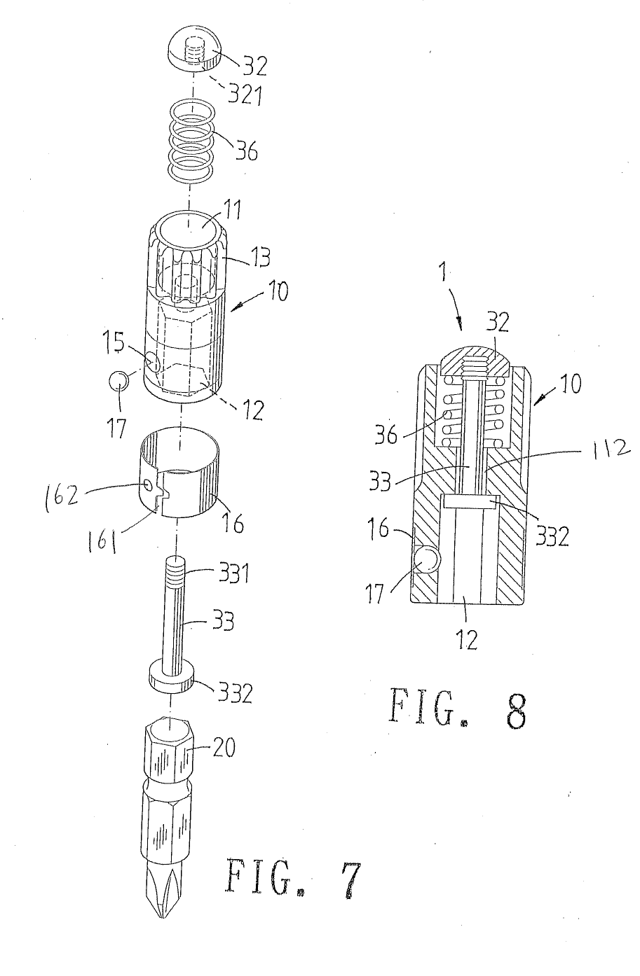

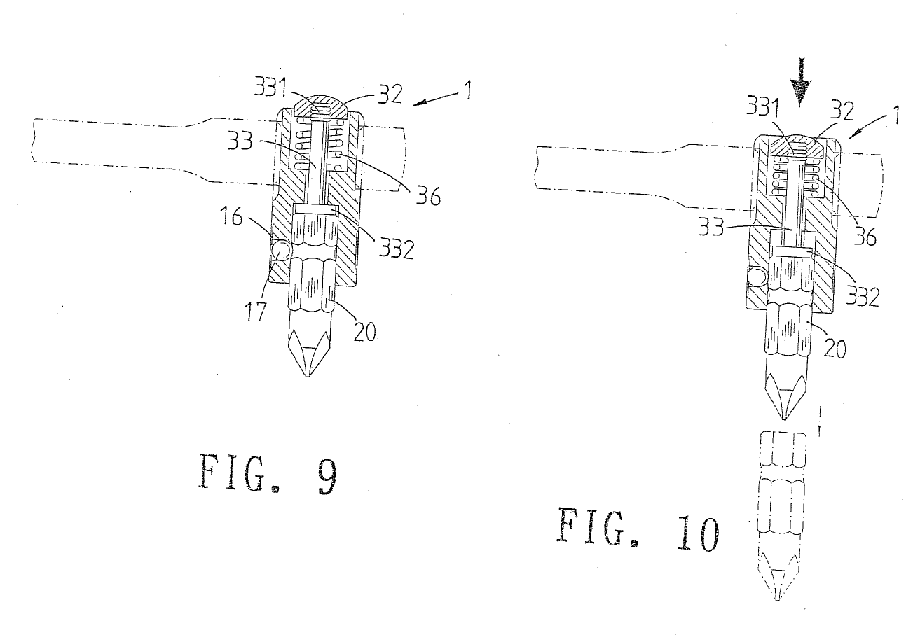

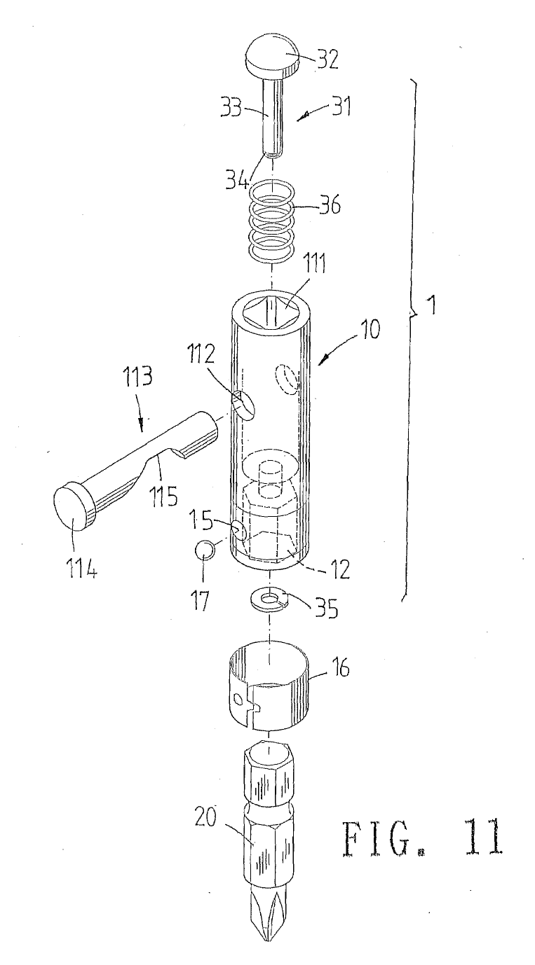

FIGS. 7 to 10 show a second embodiment of the present invention, wherein the head 32 and the shank 33 are two separated pieces and the head 32 includes a threaded hole 321 defined in an underside thereof and the shank 33 has a threaded end 331 which extends through the second recess 12, the passage 112 and the first recess 11 so as to be threadedly connected to the threaded hole 321 of the head 32. An enlarged portion 332 is connected to the other end opposite to the threaded end 331 to prevent the shank 33 from being pulled out from the first recess 11 of the socket 10. The strip 16 is a ring and is made of spring steel. The strip 16 has a seam 161 defined therein and extended therethrough for providing a resilient force to push the bead 17 into the second recess 12. The strip 16 further has a through hole 162 defined therein and corresponding to the bead 17. A diameter of the through hole 162 is smaller than that of the bead 17 such that the bead 17 is firmly positioned in the side hole 15.

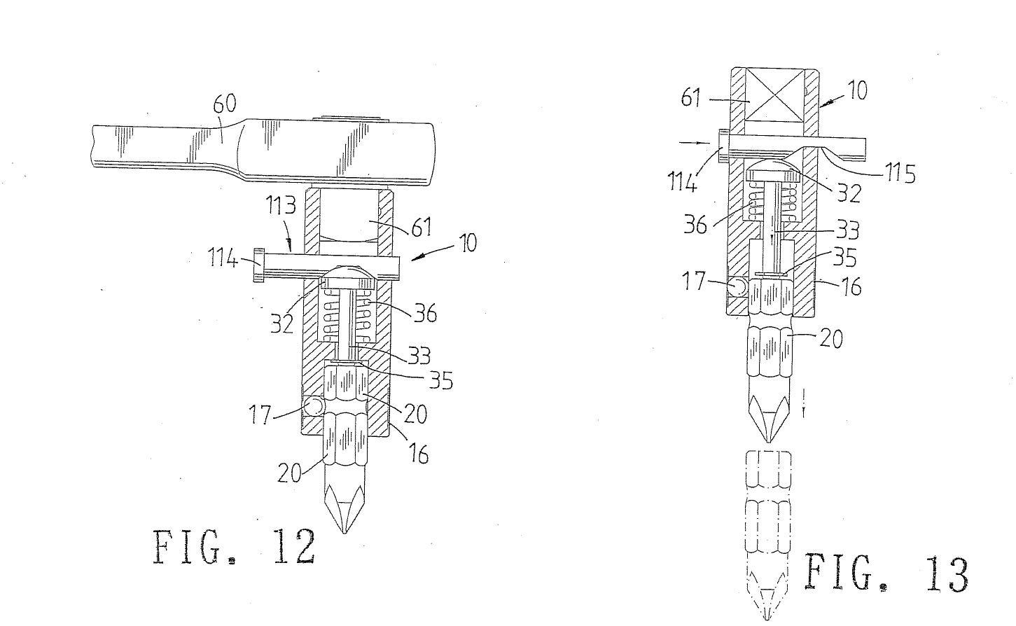

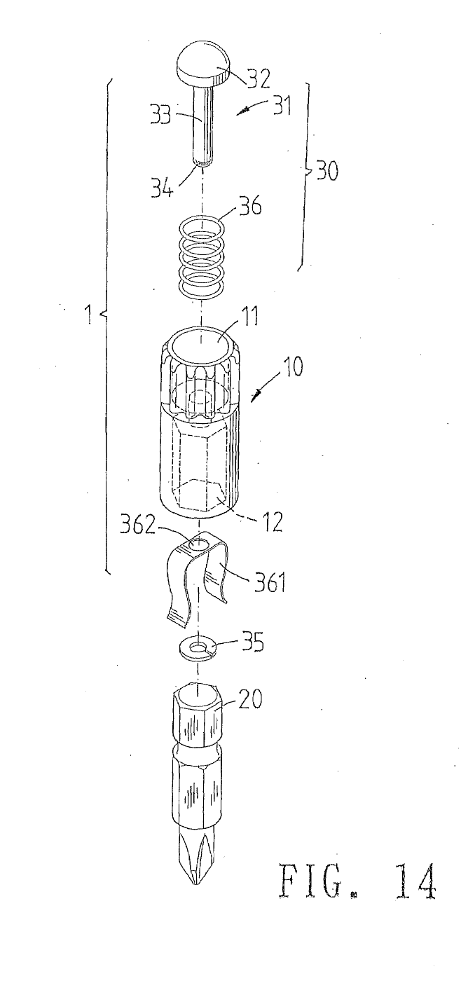

FIGS. 11 to 13 show a third embodiment of the present invention. A push bar 113 transversely and movably extends through holes 112 defined through the wall of the socket 10 and has a reception recess 115 defined radially in an outer surface thereof. A head 114 is connected to an end of the push bar 113 so as to prevent the pushing bar 113 from being pulled out from the socket 10. The head 32 of the push rod 31 is engaged with the reception recess 116, so that the push rod 31 is pushed toward the second recess 12 when the push bar 113 is transversely moved. The first recess of the socket 10 is a polygonal recess 111 so as to receive a drive shaft 61 of a wrench to rotate the socket 10.

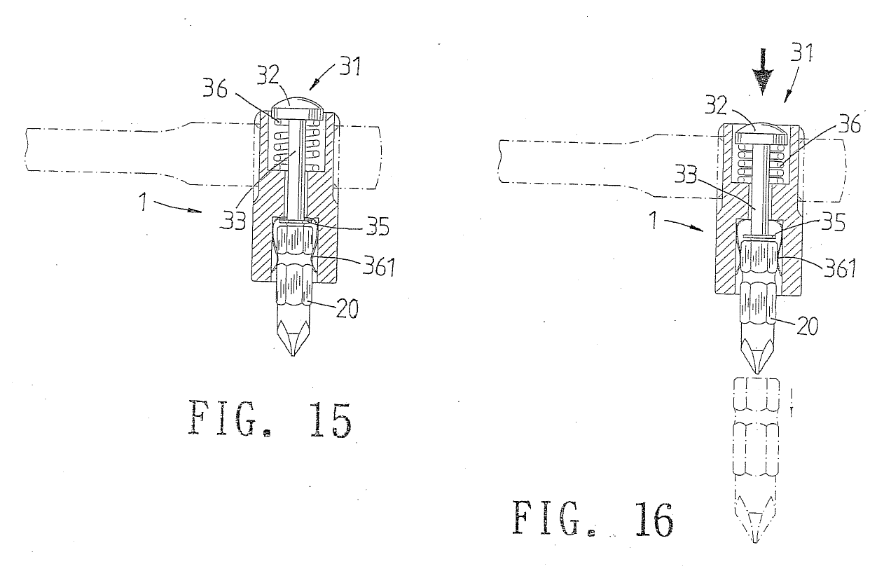

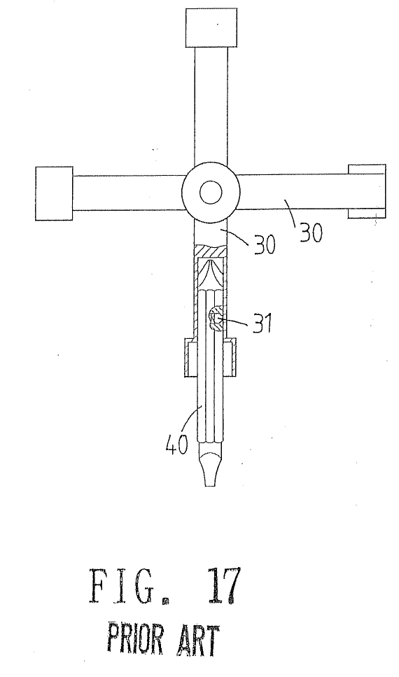

FIGS. 14 to 16 show another embodiment of the positioning device of the present invention. The positioning device is a U-shaped strip received in the second recess 12 and includes two legs 361 and a connection portion connected between the two legs 361. A hole 362 is defined through the connection portion and the shank 33 of the push rod 31 movably extends through the hole 362 in the connection portion. The two legs 361 each have an inward portion so that the screw bit 20 is clamped therebetween. When pushing the push rod 31, the shank 33 pushed the screw bit 20 which is then released from the inward portions of the two legs 361.

Although the invention has been explained in relation to its preferred embodiment, it is to be understood that many other possible modifications and variations can be made without departing from the spirit and scope of the invention as hereinafter claimed.

What is claimed is:

1. A quick release bit socket assembly comprising:
a socket having a first recess defined in a first end thereof, a second recess defined in a second end thereof, and a passage disposed between the first recess and the second recess, the passage being communicated with the first recess and the second recess, the socket having a side hole defined therein and extended therethrough;
a push rod having a head and a shank, the head having a threaded hole defined in an underside thereof, the shank having a threaded end extended from the second recess to the first recess via the passage, the threaded end connected to the threaded hole, a spring mounted to the shank and biased between the head and an inside of the first recess, an enlarged portion connected to the other end opposite to the threaded end to prevent the shank from being pulled out from the first recess of the socket;
a positioning bead disposed in the side hole in the socket, a strip engaged in a outer peripheral of the socket to provide a resilient force to push the positioning bead into the second recess; and
a screw bit removably inserted in the second recess and being positioned by the positioning bead;
wherein when the push rod is pushed toward the screw bit, the screw bit is pushed out by the enlarged portion.

2. The quick release bit socket assembly as claimed in claim 1, wherein the first end of the socket has a toothed outer surface.

3. The quick release bit socket assembly as claimed in claim 1, wherein the strip has a seam defined therein.

4. The quick release bit socket assembly as claimed in claim 1, wherein the strip has a through hole defined therein and corresponding to the positioning bead.

5. The quick release bit socket assembly as claimed in claim 1, wherein the socket has an annular recessed area defined in an outer surface thereof for engaging the strip.
